(19) United States
(12) Patent Application Publication
(10) Pub. No.: US 2003/0177014 A1
(43) Pub. Date: Sep. 18, 2003

(54) System and method for displaying multiple language text during performance or play of a musical work

(76) Inventors: Robert E. Crawford, St. Louis, MO (US); Sol Guber, St. Louis, MO (US)

Correspondence Address: HAVERSTOCK, GARRETT & ROBERTS, 611 OLIVE STREET, SUITE 1610, ST. LOUIS, MO, 63101, US

(21) Appl. No.: 10/365,110

(22) Filed: Feb. 12, 2003

Related U.S. Application Data
(60) Provisional application No. 60/356,614, filed on Feb. 13, 2002.

(51) Int. Cl. G10L 11/00

(52) U.S. Cl. 704/276

(57) ABSTRACT

A system and method for displaying text of a musical work in multiple languages as the work is performed or played, which include the steps of:

a.) providing a file including segments of the text in at least two languages;

b.) providing information representative of when each of the segments of the text is to be sung in the work, respectively;

c.) providing a display device for displaying the segments of the text in the at least two languages; and then

d.) displaying the segments of the text in a sequential order responsive to the information when sung in the work.

This application claims the benefit of U.S. Provisional Application No. 60/356,614, filed Feb. 13, 2002.

This application incorporates by reference the following material on the enclosed 2 compact disks which are duplicates of one another.

| Editor Ascii Code | | | |
|---|---|---|---|
| AdjustNudge.txt | 1 | KB | Feb. 11, 2003 |
| Background.txt | 1 | KB | Feb. 11, 2003 |
| Change_Colors.txt | 4 | KB | Feb. 11, 2003 |
| Cimi.txt | 154 | KB | Feb. 11, 2003 |
| Directions.txt | 1 | KB | Feb. 11, 2003 |
| Edit.txt | 22 | KB | Feb. 11, 2003 |
| Form1.txt | 32 | KB | Feb. 11, 2003 |
| Form2.txt | 6 | KB | Feb. 11, 2003 |
| Form3.txt | 1 | KB | Feb. 11, 2003 |
| Form4.txt | 1 | KB | Feb. 11, 2003 |
| Form5.txt | 1 | KB | Feb. 11, 2003 |
| FormPlayer.txt | 25 | KB | Feb. 11, 2003 |
| FrmEncode.txt | 25 | KB | Feb. 11, 2003 |
| Loudness_Adjust.txt | 1 | KB | Feb. 11, 2003 |
| ModifyTimes.txt | 6 | KB | Feb. 11, 2003 |
| Module2.txt | 8 | KB | Feb. 11, 2003 |
| Modulo1.txt | 45 | KB | Feb. 11, 2003 |
| MultiPick.txt | 13 | KB | Feb. 11, 2003 |
| MV2.txt | 16 | KB | Feb. 11, 2003 |
| MyClipboard.txt | 1 | KB | Feb. 11, 2003 |
| NewACGForm.txt | 3 | KB | Feb. 11, 2003 |
| Numeric.txt | 5 | KB | Feb. 11, 2003 |
| PicturePiece.txt | 11 | KB | Feb. 11, 2003 |
| Prompter.txt | 3 | KB | Feb. 11, 2003 |
| SaveHow.txt | 4 | KB | Feb. 11, 2003 |
| Shortened.txt | 5 | KB | Feb. 11, 2003 |
| ShowEffects.txt | 2 | KB | Feb. 11, 2003 |
| Split_Lyrics.txt | 11 | KB | Feb. 11, 2003 |
| TextOrder.txt | 3 | KB | Feb. 11, 2003 |
| Three_Lyrics.txt | 18 | KB | Feb. 11, 2003 |
| Timer.txt | 10 | KB | Feb. 11, 2003 |
| TinyPic.txt | 1 | KB | Feb. 11, 2003 |
| Welcome.txt | 1 | KB | Feb. 11, 2003 |
| Player Ascii Code | | | |
| ACGFileList code.txt | 2 | KB | Jan. 1, 2003 |
| Background code.txt | 1 | KB | Jan. 1, 2003 |
| ChangeACA code.txt | 3 | KB | Jan. 1, 2003 |
| Drag drop code.txt | 154 | KB | Jan. 1, 2003 |
| Form1 code.txt | 53 | KB | Jan. 1, 2003 |
| form2.code.txt | 53 | KB | Jan. 1, 2003 |
| form2nm code.txt | 1 | KB | Jan. 1, 2003 |
| Form3 code.txt | 1 | KB | Jan. 1, 2003 |
| Form4 code.txt | 1 | KB | Jan. 1, 2003 |
| Form5 code.txt | 1 | KB | Jan. 1, 2003 |
| Form6 code.txt | 1 | KB | Jan. 1, 2003 |
| frmAbout code.txt | 7 | KB | Jan. 1, 2003 |
| frmSplash code.txt | 4 | KB | Jan. 1, 2003 |
| Module CSMI code.txt | 154 | KB | Jan. 1, 2003 |
| Module 1 code.txt | 43 | KB | Jan. 1, 2003 |
| Prompter code.txt | 3 | KB | Jan. 1, 2003 |
| ShowESC code.txt | 1 | KB | Jan. 1, 2003 |
| Vertical_Control code.txt | 3 | KB | Jan. 1, 2003 |

### TECHNICAL FIELD

This application relates generally to displaying text during a musical performance or playing of a musical work, and more, particularly, to a system and method for displaying the text, particularly the lyrics or words of the music in the language the music is being sung in and also in at least one additional language, in desired timed relation to the performance, and optionally, accompanied by visual images that complement the music or performance.

### BACKGROUND OF THE INVENTION

It is believed that appreciation and enjoyment of music, particularly when performed in a language that the listener does not know or has only limited understanding of, is increased by the provision of an accompanying translation into a language known or understood by the listener.

In this regard, it is known to provide subtitles or translations of the musical verses, for instance, projected on a screen, wall or other surface, or displayed by an electronic or video device, in accompaniment to the music, particularly opera. However, it is not known is to provide both the text of the music in the language being sung and in one or more other languages, nor is it known to provide flexibility for timing with a live performance and for adapting the translation or translations to last minute deviations from the musical score or script and improvisations.

Thus, what is sought is a method and system for providing an accompanying text or lyrics of a musical piece in both the language that it is being sung in and at least one other language, which provides linguistic, artistic and creative flexibility in the production of the accompaniment for more accurately conforming to changes and improvisations in the music, and for enhancing the listener's experience during the performance or playing of the music, and which can optionally include a customized and coordinated visual accompaniment.

### DISCLOSURE OF THE INVENTION

What is disclosed is a system and method to present words which are tied to music, especially music in foreign languages, and an optional visual accompaniment that provides the above sought features and capabilities. The invention includes an editor which records times at which individual lines of text, such as, but not limited to, the lyrics, are presented in relation to a corresponding musical piece. The editor may also store an indication of the particular manner in which the text is displayed, such as, but not limited to, the color and font and other aspects of the text. The manner in which the text is displayed may be changed from piece to piece or even within a single piece of music.

The present invention represents a pioneering effort in the area of presenting the lyrics corresponding to musical performances in multiple languages. By presenting the lyrics in multiple languages, a listener can not only have a sense of the meaning of what is being sung, but can also contemplate the original language of the song, even if the listener is the only slightly familiar with the language or even completely unfamiliar with it.

The text and optional images which are preferably presented using the present systems and methods are intended to form a part of the musical presentation. Rather than being presented in a way which is unobtrusive and does not distract from the performance, the text and/or images are preferably intended to be unobtrusive, if you will, so that they enhance the performance instead of blending in with the surroundings, as might be desired in an opera.

The invention may be embodied in many different types of media, such as currently known CD-ROMs, “video-on-demand”, various memory devices, handheld devices, and so on. One of the advantages provided by the present systems and methods is that the volume of information needed to produce the music and corresponding visual display in a “video-on-demand” context is substantially reduced from that of comparable conventional means for producing the same audiovisual performance, such as a videotape recording. This is primarily a result of the preferred use of still images instead of actual video. Consequently, the performance uses less transmission bandwidth and a greater number of such performances can be made available on the same transmission (e.g., broadcast) system.

The present systems and methods were designed primarily for use in conjunction with the presentation of concerts. Accordingly, the present systems and methods will be described primarily in the context of such concerts. It should be noted, however, that they are applicable in other contexts as well, and are not limited to application in a concert context.

In one preferred embodiment, the application of the invention is configured to operate in either of two modes: an automatic mode; and a manual mode. In the automatic mode, the application is configured to utilize the timing information associated with the music to trigger the presentation of corresponding lyrics and/or images at the appropriate times (i.e., in synchronization with the corresponding portion of the music). In the manual mode, the application is configured to present the lyrics and/or images at times indicated by the manual cueing of a user. For example, the next line of text or image may be presented when the user clicks a mouse button or hits a key on the keyboard.

Another preferred embodiment of the invention comprises a system having one or more computers coupled to a projector, wherein the projector is configured to display text and/or images on a screen or other part of the stage during a live performance of a musical piece. One such embodiment utilizes the application described above which includes a manual mode of operation. Because the time of the music in a live performance may not be exactly the same as the recorded version of the same music, automated presentation of the text and/or images based on timing associated with the recorded music may not exactly match the timing of the live performance of the music. Therefore, an operator of the system provides real-time timing information by clicking a mouse or hitting a key on the computer keyboard or activating another input or cueing device whenever the next line of text or image should be displayed.

A system for use during live performances should also have multiple displays so that the system operator can view information relating to the use of the system. For example, it may be helpful for the operator to be able to see upcoming lines of text so that he or she can determine the appropriate time to trigger the display of the text. It may also be helpful for the operator to be able to select individual musical pieces from a list of files in order to present the correct text and images in the event that the performer of the musical piece does not follow a predetermined order. It may also be helpful for the system operator to be able to preview the text and/or images which will next be displayed. It may also be helpful for the system operator to be able to view an image of the text and any images that are currently being displayed. These can all be provided with the present system.

In order to facilitate the display of information to the system operator, the application may be configured to produce multiple windows that can be displayed on a system monitor. For example, the display may have a first window in the upper half of the monitor for viewing the currently displayed text/images. The lower half of the display may comprise a window containing a preview of the next line of text or image to be displayed. Additional windows may also be displayed to provide information to the operator on, e.g., available files, text fonts and colors, and so on. In one embodiment, the system includes multiple monitors so that, for example, the currently displayed text and images can be shown on one monitor, while previews and other information used by the operator are shown on a second monitor.

Some of the preferred features include: dual-mode (auto/manual prompting), two-screen control (control portion of screen/display portion of screen), timing associated with music (file format), dynamic assignment of style (color/font) files to music files, timing data triggers text/images, auto-adjustment of text size if too big, font/color switching between songs/pieces, add effects to display of text/images, select files (songs) in any order, and skip lines within the song (select in displayed text).

### BRIEF DESCRIPTION OF THE DRAWINGS

FIG. 1 is an illustration representative of an install screen for a player program for the method and system of the present invention;

FIG. 1A is an illustration representative of an icon for the player;

FIG. 2 is an illustration representative of a screen of the player showing a control panel feature thereof;

FIG. 3 is a high level flow diagram, showing steps of operation for the player;

FIG. 3A is a continuation of the flow diagram of FIG. 3;

FIG. 4 is an illustration representative of another screen for the player of the present invention showing the control panel;

FIG. 5 is an illustration representative of another screen for the player of the present invention showing only a control strip of the control panel;

FIG. 6 is an illustration representative of another screen for the player of the present invention;

FIG. 7 is an illustration representative of another screen for the player of the present invention, showing a prompter screen;

FIG. 8 is an illustration representative of another screen for the player of the present invention, showing a lyrics splitter screen;

FIG. 9 is another prompter screen for the player of the present invention;

FIG. 10 is an illustration representative of another screen for the player of the present invention, showing text lines displays;

FIG. 11 is an illustration representative of another screen for the player of the present invention for modifying text aspects;

FIG. 12 is an illustration representative of an initial screen for an editor program of the present invention;

FIG. 13 is an illustration representative of another screen of the editor of the present invention for editing music;

FIG. 14 is an illustration representative of a screen for a visual editor program of the present invention;

FIG. 15 is a high level flow diagram, showing steps of operation of the music editor program;

FIG. 16 is another high level flow diagram, showing steps of operation of the visual editor program; and

FIG. 17 is a simplified representation of hardware for the system and method of the present invention.

### DETAILED DESCRIPTION OF PREFERRED EMBODIMENTS

The present invention is described in reference to the drawings.

The present invention is preferably embodied in a multimedia presentation program that integrates and times the presentation of text and fixed image material to either pre-recorded music or live concert presentations. The raw material of the invention consist of digital music files such as mpeg, image files such as jpeg, and text files calling upon the usage of existing fonts. It is the rendering and timing techniques of these texts and images to the music being played that are pertinent to the invention and will thus be described in detail.

Presently, a memory device such as a CD-ROM including the controlling software of the system contains an automatic Install procedure as well as various content.

Player

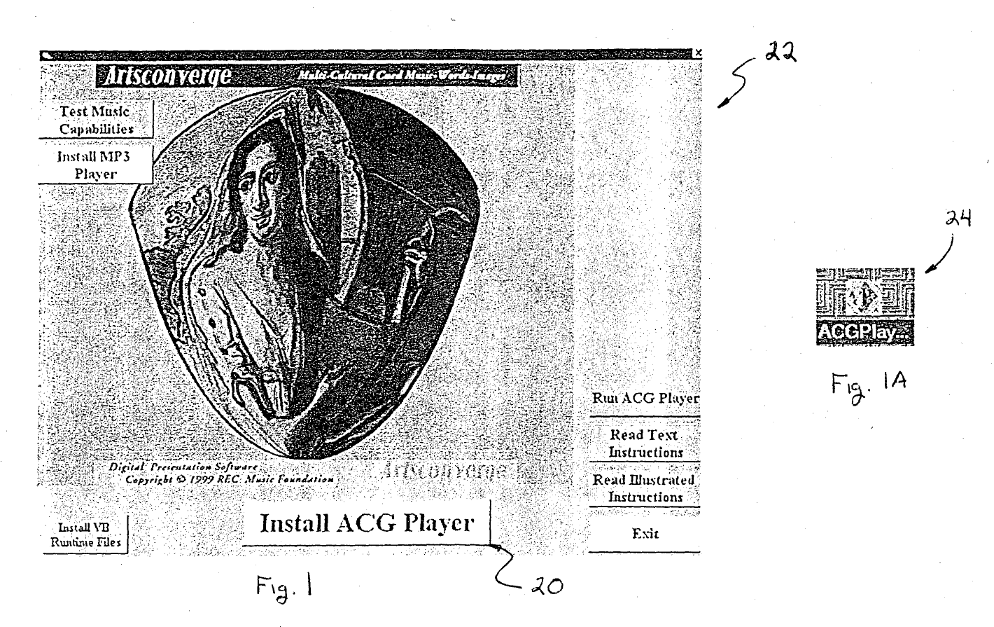

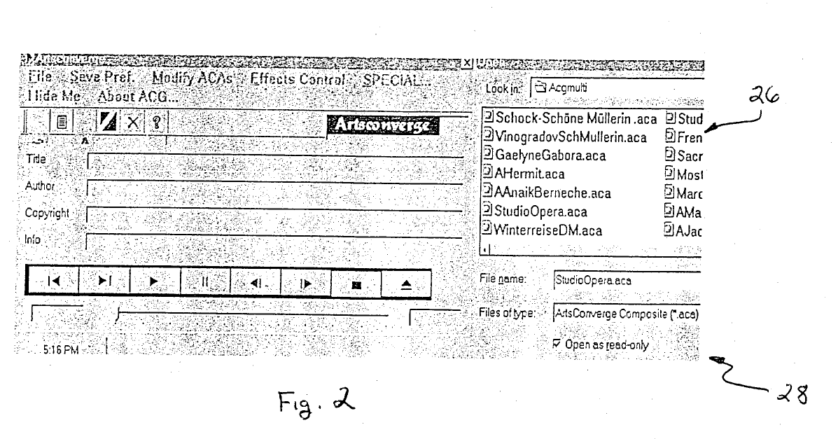

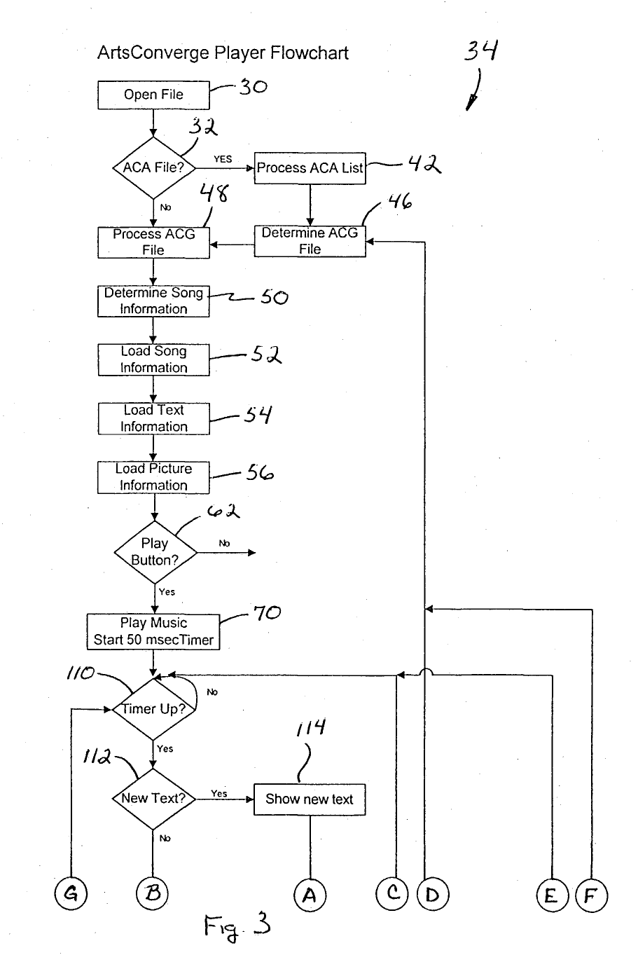

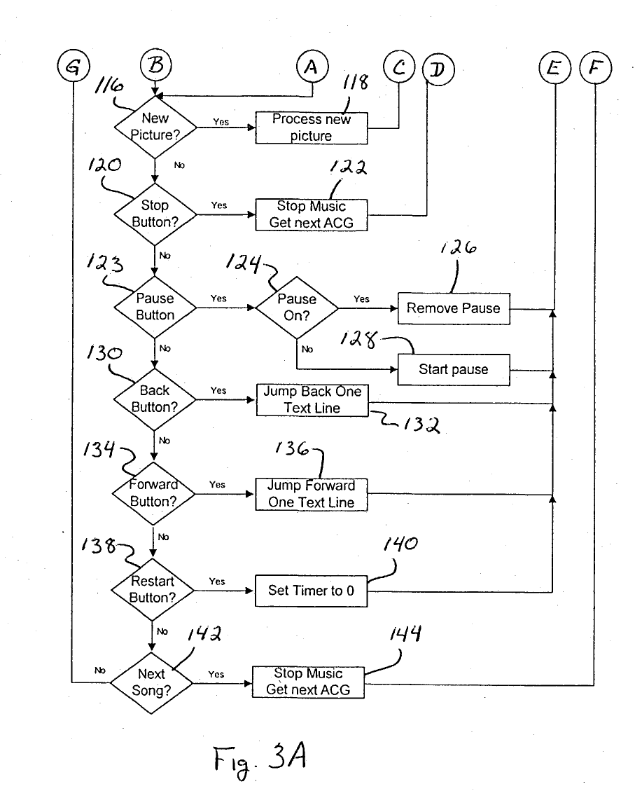

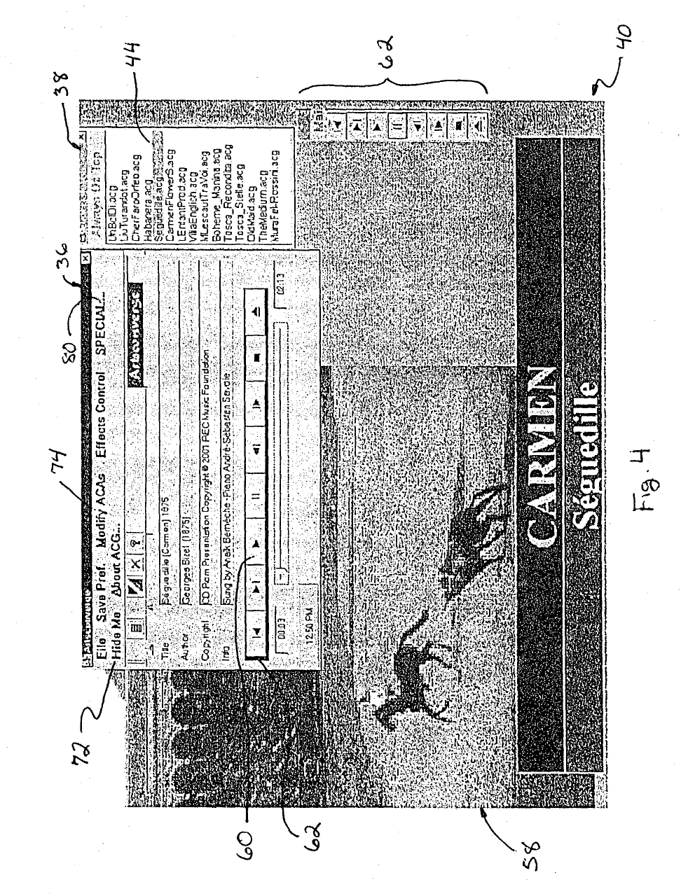

Referring to FIGS. 1 and 1A, selecting the Install procedure option 22 on a Title Page screen 20 will write the pertinent portions of the Player software to a computer hard drive and leave a shortcut icon 22 on the desktop. This can be currently done using any suitably capable commercially available personal computer which can access the program through a drive or a communications network such as the World Wide Web. The present embodiment of the invention is written in the Visual Basic language for a Windows operating system, but could be written in other languages for other operating systems as well. Henceforth a click on icon 24 will launch the Player producing a standard dialogue in which the user will “Open” either an individual group file, denoted as a “acg’ or “ACG” file, or the choice of a group listing of files, denoted as “aca” or “ACA”, as illustrated by the listings in a window 26 on a screen 28 in FIG. 2, and as depicted by blocks 30 and 32 in a flow diagram 34 shown in FIG. 4. When an aca file is selected to be opened, a Control Panel 36 and an aca List 38 appear on a screen 40, as illustrated in FIG. 4, and by block 42 in FIG. 3. Clicking on any listing, such as shown by selection 44 will initiate that piece. The material will play from the CD-ROM containing the program, or it can be dragged to the Hard Drive and will play from there. The instruction file has an “.acg” extension. It contains identification of the material that shows in the control panel and refers to mpeg or wav files (music) and jpeg or other image files that are present in the folder in which it resides as well as image presentation effect code and texts which hold times of their appearance to a clock that is launched as the piece is started. This is shown as steps 46, 48, 50, 52, 54 and 56 in diagram 34. If, at block 32, an acg file was originally selected, the process would have skipped steps 42 and 46. Here, the selection 44 is “Seguedille.acg” and the music file or files; the image file or files; and texts for that piece are loaded, and a first image 58 for that piece is displayed.

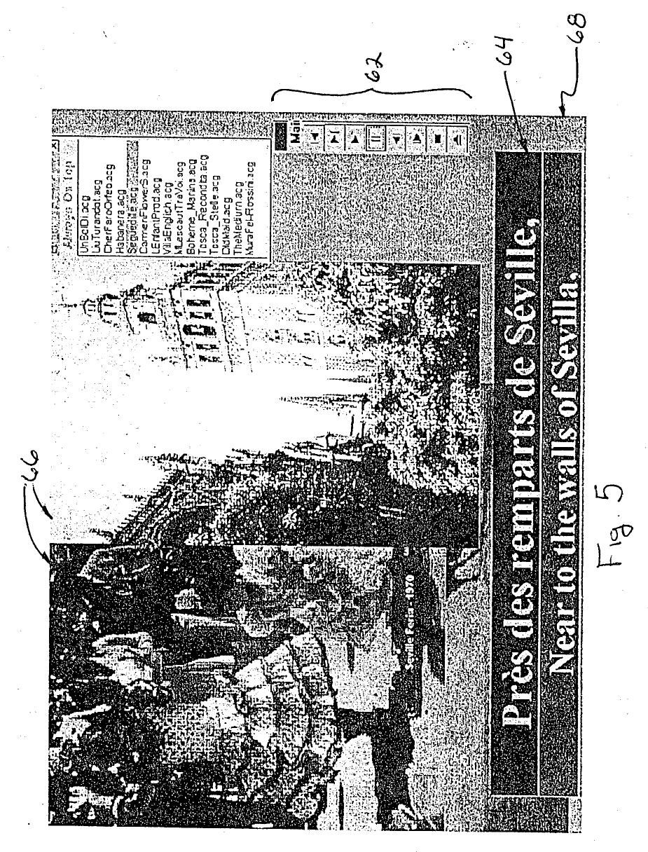

Next, to play the piece, a play button 60 on a control strip 62 on control panel 36 is clicked on or selected, as shown in FIG. 4. As the piece is played, text 64 and an image or images 66 will be displayed, as illustrated on screen 68 in FIG. 5. The user can pause, jump to the next set of lines, jump backward, and/or repeat the current line by clicking on or otherwise selecting buttons on control strip 62. Referring to FIG. 3, as noted above, when the music is played, a timer is activated, as denoted at block 70.

Features of Player Control Panel

Hide Me 72, clicking here removes the Control Panel from the screen so that it does not interfere with the images. Hitting the escape key restores it. An adjunct to this is the small band of buttons of the control strip 62 persists to still maintain the dynamic controls even in the absence of the main Control Panel 36.

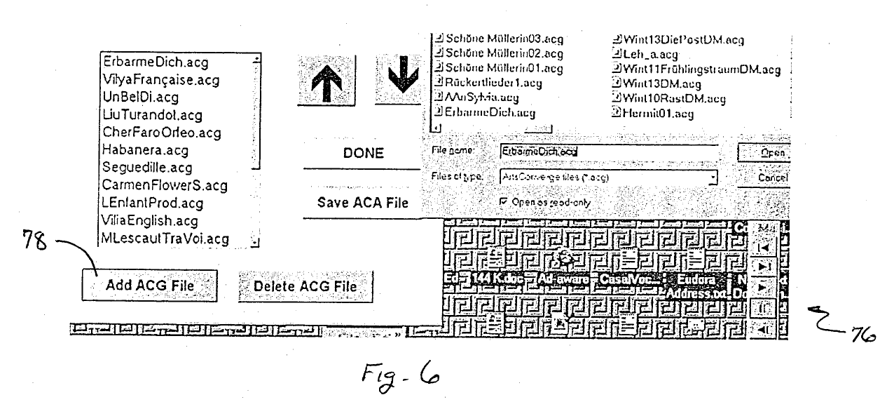

Modify ACAs 74 (image)—clicking on this facility enables the easy creation of an aca file list from resident acg files, as shown by screen 76 in FIG. 6. Add Acg Files 78 produces that address dialogue for a selection.

Special 80 (image) on screen 40 (FIG. 4)—colored background (check toggle). Eliminates or reinstates the colored background that masks the desktop. Other features of special are covered below under the Prompter section.

Prompter

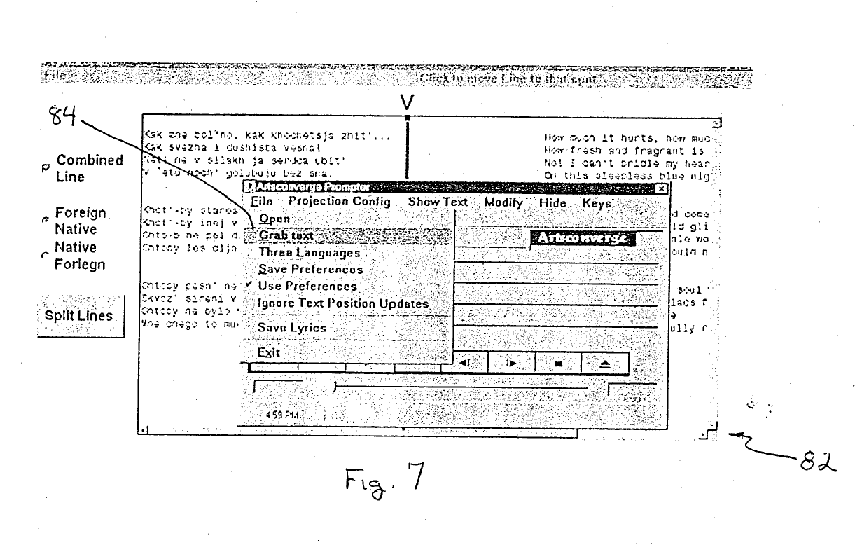

Referring to FIG. 7, a Prompter screen 82 is shown. The primary function of the Prompter is to assist in the preparation of Acg files that can govern either cueing in a live concert or also be used with captured clock times (see Editor below) for the Player.

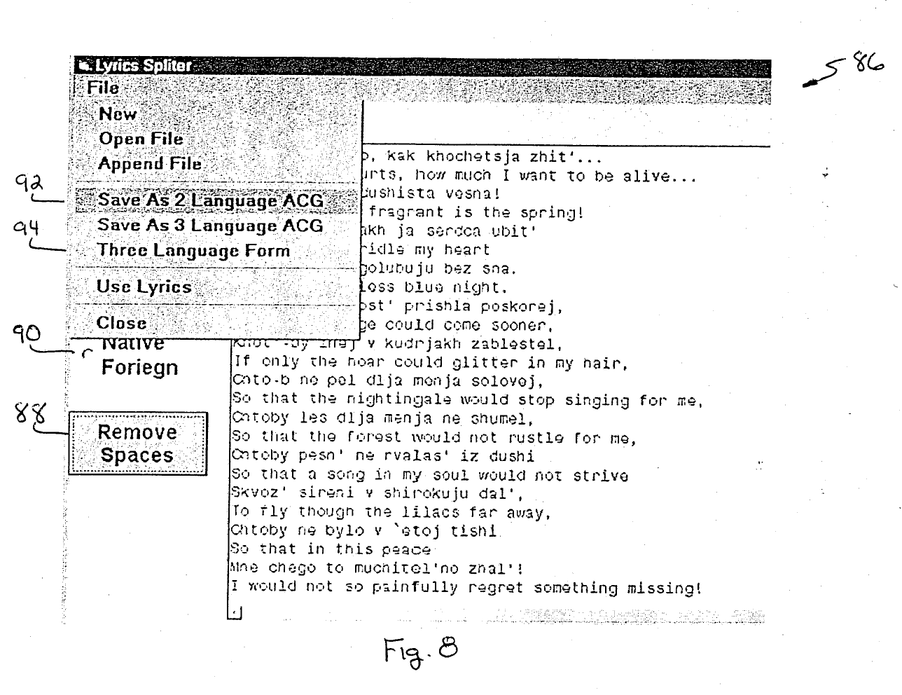

Grab Text 84—under File pull down produces Lyrics Splitter screen 86 shown in FIG. 8. A paste of text is made to this screen of textual material.

Remove Spaces 88 consolidates this text and alternates languages in some instances, especially as an example from “The Lied and Song Text Page” as available at the time of the filing of the subject patent application at the website www.remusic.org. If the Paste format requires a separation of the languages, Combine Line facilitates this or allows for individual Pastes. Again, Remove Spaces 88 alternates the languages. The check of Native or Foreign 90 will govern which language text will be presented on Top. Finally, in the File Pull down on this screen, a Save As 92 will create and save an Acg File in the format required for both the Player and the Prompter, as follows.

Dummy Title
Dummy Author
Dummy Copyright
Dummy Info'
Dummy.MP3
0[Kak mne bol'no, kak khochetsja zhit'...] How much it hurts, how much I want to be alive ...
0[Kak svezha I dushista vesna!] How fresh and fragrant is the spring!
0[Net! Ne v silakh ja serdca ubit'] No! I can't bridle my heart
0[V 'etu noch' golubuju bez sna.] On this sleepless blue night.
0[Khot-by starost' prishla poskorej,] If only old age could come sooner,
0[Khot'-by inej v. kudrjakh zablestel,] If only the hoar could glitter in my hair,
0[Chto-b ne pel dlja menjha solovej,] So that the nightingale would stop singing for me
0[Chtoby les dlja menja ne shumel,] So that the forest would not rustle for me,
0[Chtoby pesn' ne rvalas' iz dushi] So that a song in my soul would not strive
0[Skvoz' sireni v shirokuju dal',] To fly through the lilacs far away,
0[Chtoby ne bylo v 'etoj tishi] So that in this peace
0[Mna chego to muchitel'no zhal'!] I would not so painfully regret something missing!

Notice that there are no times as yet or header information. But this is all that is needed for use in live concert cueing. A file titled Dummy.MP3 must be in the same common folder. (Or a substitute can be hand edited for practice purposes). Below is a finished acg file that also includes information about images and their presentation effects as used in the Player (see below). It can also be used in a live concert. (Cue times—first column—are ignored in the Prompter).

Séguedille (Carmen) 1875
Georges Bizet (1875)
CD Rom Presentation Copyright © 2001 REC Music Foundation
Sung by Anaík Bernéche-Piano André-Sébasten Savoie
Seguedille.mp2
0[CARMEN] Séguedille
1[<Rejon&Toro.jpg]#22,5,3,0,0,0,0,0,0#Start1
15000[<FerLitGirls.jpg]#0,0,0,0,0,0,0,0,0#Start2
l6000[Ghiralda.jpg]#0,0,0,0,0,0,0,−192,4848#Start3
16470[Prés des remparts de Séville,] Near to the walls of Sevilla,
20780[Chez mon ami Lillas Pastia,] At the tavern of my friend Lillas Pastia.
24690[J'irai danser la Séguedille] I'll soon dance the gay Seguedilla,
27550[Et boire du Manzanilla.] And I'll drink Manzanilla.
31780[Chez mon ami Lillas Pastia.] At the tavern of my friend Lillas Pastia.
41410[Oui, mais toute seule on s'ennuie,] Yes, but drinking alone is boring.
43930[Et les vrias plaisirs sont á deux;] True joy begins when there are two;
46180[Donc. Pur me tenis compagnie,] And so, to keep my company,
48220[J'emménerai mon amoureux!] I'll take my lover with me!
52170[Mon amoureux ... il est au diable,] My lover ... that is a problem,
56240{Je l'ai mis á la porte heir!] He is nowhere to be found!
58720[Mon pauvre couer trés consoldable,] Now my poor heart needs consolation,
63000[Mon coeur est libre comme l'air!] My heart is free as air!
67730[J'ai des galants á la douzaine,] Tho' I have suitors by the dozen,
68000[<FerLitGirls.jpg]#0,0,0,0,0,0,0,0,0#Stop2

A three language presentation can be prepared by clicking on Three Languages 94 on the File pull down, which calls for three pastes or an amended first paste to an existing acg file. The order of these languages can be specified.

All of the above saves much effort in the preparation of material.

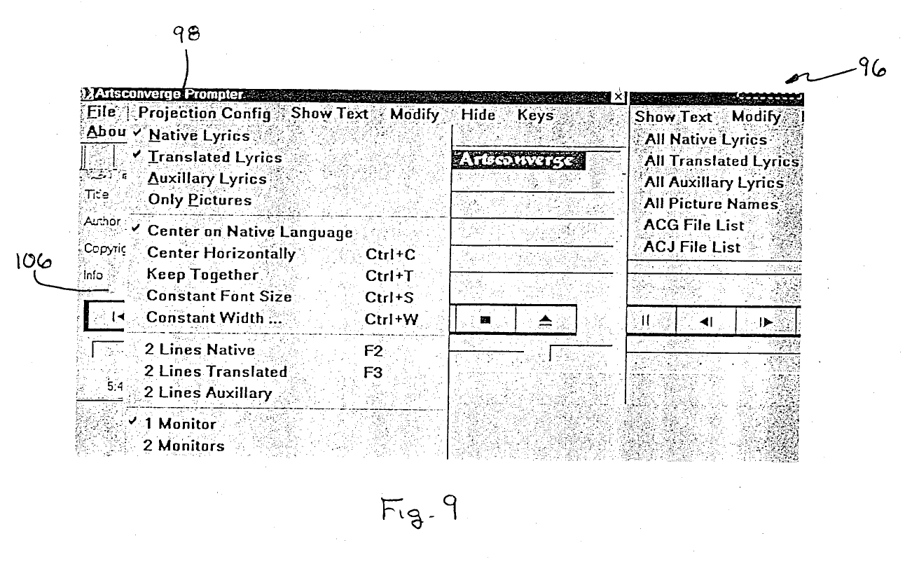

Referring to FIG. 9, On the Prompter screen 96—Projector Configuration and Show Text—In a live concert situation, it is important that the Operator that cues the material have access to controls. The system is designed to be activated from one computer, but ideally that computer will be able to recognize two monitors, one of which is the digital projector which will receive just what the audience is to see, while the computer monitor will show aca lists of the upcoming program, acg texts, and image lists. This mode is activated from Projection Configuration pull down 98 (image), via the 1 monitor or 2 monitor toggle checks. This pull down has other toggles at the top that activate windows that will appear or not on the computer screen.

In the example below, various operator windows are opened. The position of these windows can be preserved as part of an acp file (below) attached to a specific song. The sizes and choices of fonts in the window lists can also be selected.

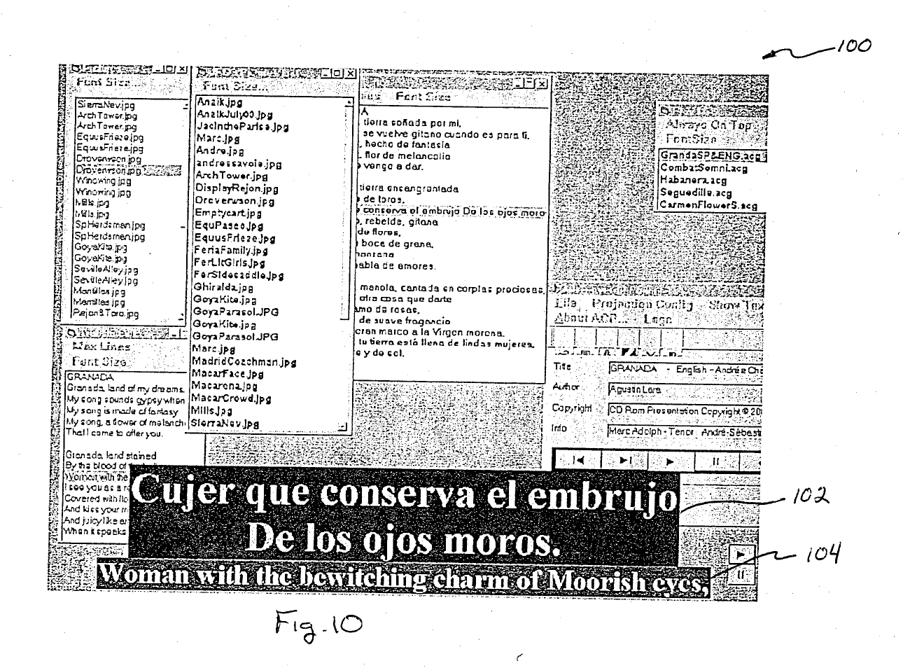

Referring to FIG. 10, screen 100 is a very busy screen even with no images. In real use, the banner text and images would appear only on the second monitor (projector) while the lists and full text would appear only on the computer monitor. Notice the forced two line mode of the Spanish text banner 102 and the different size of the text in the English text banner 104.

The native language list shows all of the upcoming lines as are being sung. Normally, a spacebar press will activate the next set of lines, but also a click on any line from the list will jump to that line directly, so that if material should be omitted at the last moment or the place is lost, the audience does not have to see the intervening lines. If there is an mpeg recording in the computer of the material that will be sung live, the operator can practice the presentation by playing this file. The Prompter will ignore any clock times indicated. This is one of the advantages of having a standard file for various uses. If a recording is made of the concert, an electronic version can be made by attaching times (see Editor below). Other than the time capture, the acg file can be utilized repeatedly for various for different recordings of the piece.

Referring again to FIG. 9, the middle two sections 106 of the Projection Config pull down offers toggles that govern a wide choice of aspects of the text banners. They are somewhat self-explanatory. In part, the size of the banners are a function of the font and font size selected (see below), but the widths and functions here offer adjusts that allow for long texts to get into the banners. Each language banner is separately controllable and can be of a fixed width or can be adjusted to the length of the specific text lines at hand. This approach offers much aesthetic flexibility, which is important in that these texts are to be very bold parts of the stage picture and much a part of the production. This is a pioneering overall approach to solving the problem presented.

There are two basic ways of presenting images. The Editor (below) offers ways of presenting the images via dissolves, slide ins, and the like. The toggle that brings up picture names writes the speed and selection of these effects to the acg file. In the list that will show if Picture Names is checked (in Show Text pull down), these images and effects from the acg, if there are any, are listed, and can be activated here with a click on any one of them. The position of these images will be that called for in the acg.

Secondarily, an independent list of images (shown above in the Jpeg Images list) can be created that are not connected to the acg file but rather is attached to the aca list of files. This is done under Modify pull sown—ACJ file (image). Similar to the ACA file creation, a click on Add Acg File produces the address tree dialogue for selection. Unlike the rest of the content material (which must be in a common folder), the images of the ACJ list each carry a tree map and can reside anywhere in the computer. From this list, a check on any image will immediately produce it at a given position on the screen of the upper left corner of any image. This position can be altered by dragging an image. There are no presentation effects—it just pops up, replacing the previous image. Sub set usages of the system are contemplated, and this image presentation facility is especially simple and handy and likely will be useful in its own right, independent of the system as a whole. Its advantage over other image presentations lay in just this simplicity and immediacy.

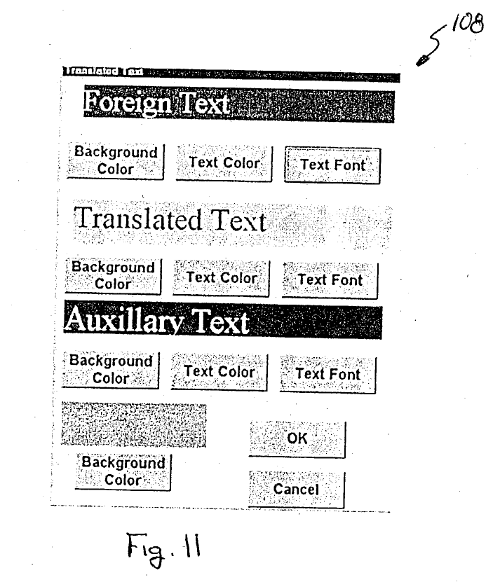

Referring now to FIG. 11, Fonts and Colors—screen 108 is found under Modify in the main pull down (FIG. 7). Clicking on the labels here takes the user to standard templates that allow for the selection of any resident Font in the computer and allows for the designation of the Font and its point size. Colors are assigned from similarly produced standard template palates assigned as indicated by the buttons. The usage of these templates (not shown) is very much an original part of the system.

ACP Files (Acp File)

All of the above configurations and text instances that are selected as above will now govern the computer. They can be saves as a general in file. However, the present program goes one step further and saves these specifications in an independent acp file. In the main file pull down (FIG. 7), if Save Preferences is clicked upon, a new ACP file will be written to the Hard Drive. For this to have significance, the content at hand needs to be running from the hard drive, not from the CD-ROM. Thus, it is recommended that after the install the content folder, as an ACGMULTI, be dragged to the desktop or elsewhere on the hard drive. When the resident acg file is activated from that location, the ACP file now being saved will be associated with that particular file. Thus, each file or song can have a completely independent set of particulars. In the main File pull down, there is a toggle—Use preferences—. When this is checked, the independent ACP file, if there is one, will kick in for any new song or acg file, but it might be that such a change is not wanted at some points. The ACP file associated within an ACG file will NOT kick in if this Use Preference toggle is unchecked. Thus less variety via the sticking with a desired resident configuration can persist if wanted. Also, a given ACP file can be assigned to different songs without having to recreate it for each usage if it stays resident and then is assigned via a Save Preference to scattered songs in one or several ACA lists. Then the Use Preference could be rechecked and a different previously created ACP would be come resident. Unchecking the Use Preferences would allow this set to be assigned to another scattered bunch of songs in the same manner. This concept of ACP files attached to individual presentations is original to the present system.

Logo—The ArtsConverge logo, that is, the name presently selected for the Player, also presented at the Install and elsewhere as in the Editor title page (see just below), can be shown at any time by the operator clicking on Show Logo. It can be given a fixed timing to persist under Logo Timing.

Referring again to the flow diagram shown in FIG. 3, during play, the program will monitor the timer, as shown at block 110. When the allotted time for a particular text is up, the program will determine whether new text is to be displayed, as denoted at block 112. If yes, the new text will be displayed, as shown at block 114. Continuing on FIG. 3A, along lines A and B, then, or if no new text is to be displayed, the program will determine if a new image is to be displayed, as shown at block 116. If yes, the new image will be processed, at block 118, and, following line C, will return to block 110. If no new picture is to be displayed, the program determines if the stop button has been pressed, as shown at block 120. If yes, the music is stopped and the next ACG file is obtained, as shown at block 122, and, along line D, the program goes back to block 46. Returning to block 120, if the stop button has not been activated, the program proceeds to determine whether the pause button has been activated, at blocks 123, 124, 126 and 128. This is a user function and the program will either pause the outputs or unpause them, depending on the user input, and will loop back through line E to block 110.

If the pause is not, or is no longer, activated, the program will determine if the back button has been activated, at block 130. If yes, the program will jump back 1 text line, as shown at block 132, and proceed along line E to back to block 110. When no back command is present, the program will determine if the forward button has been activated, as shown at block 134, and if yes, it will jump forward one text line as shown at block 136 and proceed along line E back to block 110. If the forward button is not activated, the program will proceed to determine whether the restart button is activated, as shown at block 138, and if yes, will set the timer to zero as shown at block 140, and go back to block 110. If the restart button is not activated, then the program will determine the next song at block 142, and if there is,one, will stop the music and get the next ACG file as shown at block 144 by going along line F to block 46. If there is no next song, the program will proceed along line G back to block 110.

Editor

As noted above, the present system and method preferably includes an Editor program, for allowing revising text, timing, visuals, and other aspects of the displayed matter to accompany a musical performance or play.

The Editor has two primary functions—it creates acg files after capturing timings for presentations of text lines, and of images, and it creates its own code to designated given images, parts and placements of images and the speed and presentation of these images and when they will appear or disappear.

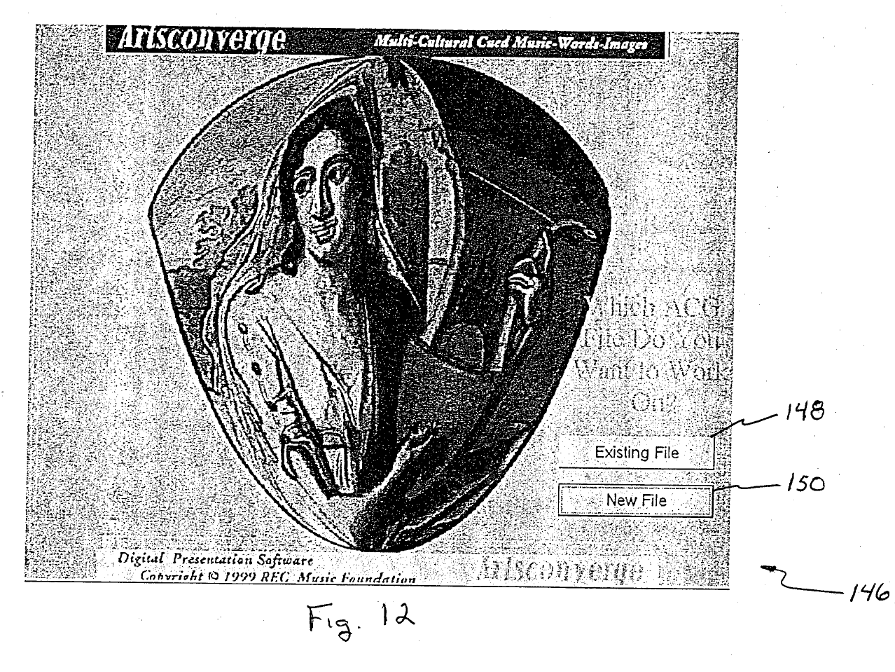

Referring now to FIG. 12, the Editor title page screen 146 calls for an existing file or a new file, as shown at 148 and 150.

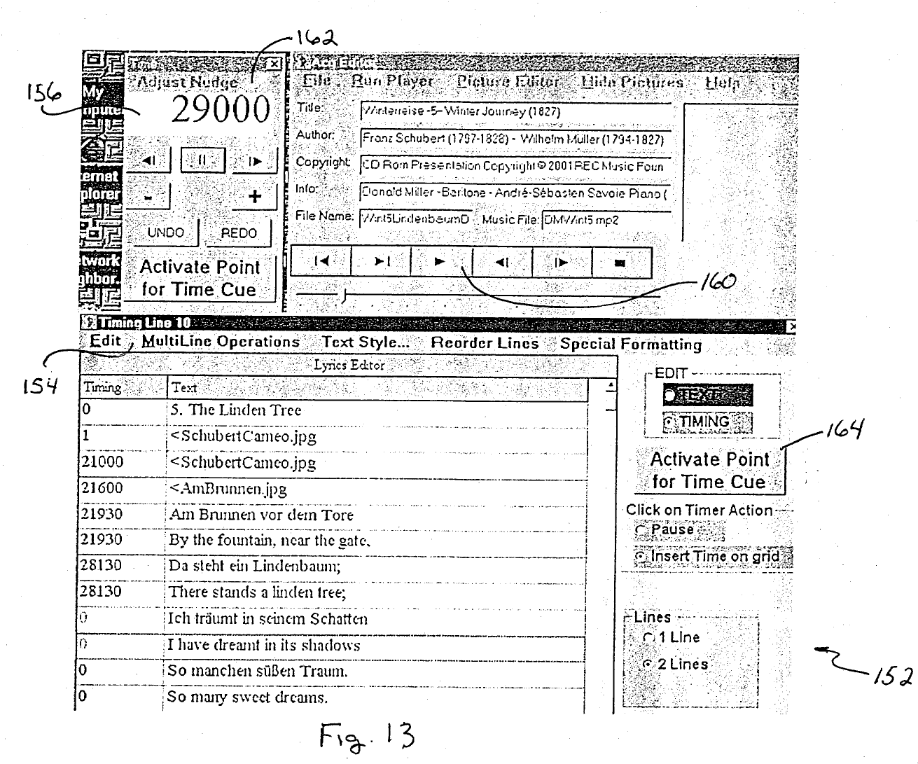

It has been found that the best normal way of dealing with the preparation is to pre-prepare the text by creating ACG files, as under the Prompter above, in which case the Existing File is called for. The whole process can also be done directly in the Editor, in which case New File is called for and a step through ensues in which the header information can be entered and either existing lyr files (individual languages) entered, or the entire text typed in directly on a grid that is presented, as shown in screen 152 in FIG. 13.

Under Multiline Operations 154, the Splitter or Grab text procedure, as in the Prompter, can also be initiated here. Once the text is entered or recaptured on the grid in either one, two or three, language inteleaved text lines, it is ready to be cued.

With timing checked, the little window Time 156 shows milliseconds on a clock that starts as the mpeg starts to play is key. With the cursor activated, at any point in the time column on the grid, a click on “Activate Point in Time Cue” 158, which turns the 0s or other numbers for the set of lines to be cued at that moment to Green. The Start button 160 on the Control Panel is clicked and the resident sound file begins to play, and at the same moment, a clock is started and numbers flash by in the timing Window 156. The cursor is poised there. By following the text being sung at the moment the highlighted line is begun, a mouse click captures the clock time and enters it in the set of lines of the Grid, and also jumps the highlight to the next set which time is captured in the same manner.

There is a facility “Adjust Nudge” 162 which can add or subtract milliseconds from the value that is entered. The purpose of this is to allow the person doing the editing to not have to follow a score to anticipate the timing, but to be able to capture the time when he or she hears the actual Word that begins a new line. About a −500 millisecond back up has been found to work well. If the user is late with a time capture click, he or she can hit the Pause button and then hit the minus button once or more which backs up the time—and then hit the pause again which as a toggle starts the music again from the backed up time and again attempt to get the cue right. If early, he or she must hit the pause and again do the “Activate Point In Time Cue” procedure using button 164, which backs up the highlight to again get the time right at that moment. Using these procedures, cueing mistakes can be corrected at any time easily without having to redo the whole piece. When the timing is complete, it can be checked by playing the piece in the Text mode whereby the times will be highlighted in red or via Run Player, which shows banners.

Finally, the result is saved and an ACG file with the cue times attached is created.

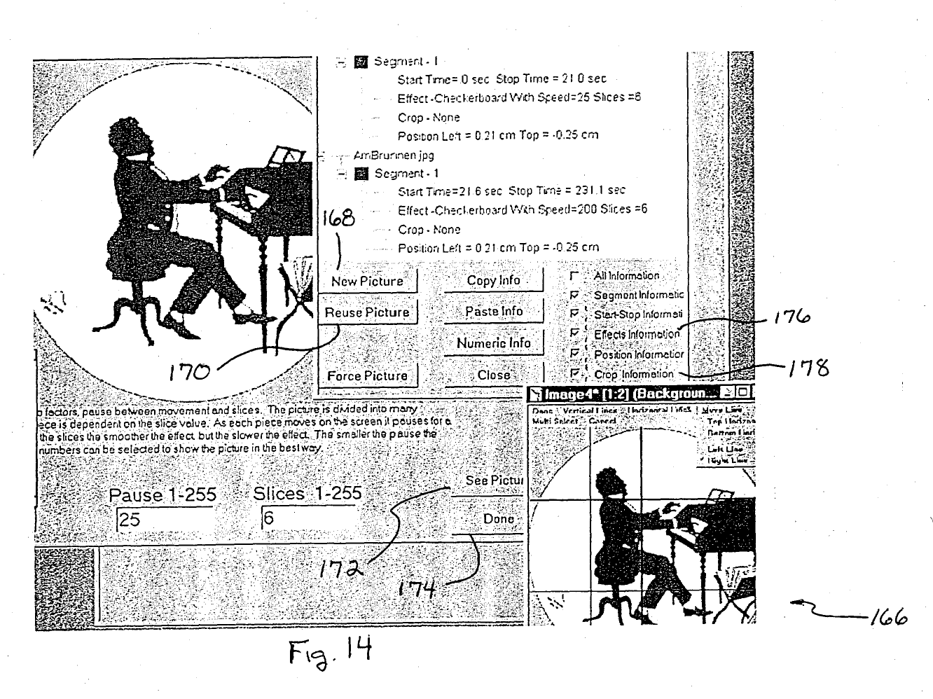

Referring to FIG. 14, the other main section of the Editor is the Picture Editor as shown by screen 166. When this is clicked upon, a facility appears to enable the treatment of images.

New Picture 168 produces the standard dialogue to select any image from the common folder to add to images that will appear during the acg or song at hand. Re-use Picture 170 produces another instance. Each instance shows a sub-set which calls for a Start-Stop time effect, Crop (see below), and Position. This latter simply produces the image on the screen which can then be dragged somewhere and when Done is clicked, will capture the coordinates of the upper left corner which will then preserve that spot position on the screen where the image will later appear. Several images can be thus saved to various places and can appear and be removed at designated times.

Under Effects 176, a choice of various dynamic presentations of the image are offered, including speeds and slices of that effect. See Picture 172 gives an immediate demonstration of what was designed. Done 174 preserves the code numbers that will later be entered on the acg to produce this effect when the image presents.

Under Crop 178, a facility appears whereby an image can be divided into up to nine sections of different sizes rectangles that is achieved by entering one or two vertical and one or two horizontal lines and then moving them via the arrow keys on the computer keyboard. Each instance of this cropping is recreated back on the main Picture form or further treatment.

Ultimately, all of the image instances are shown on the Grid and the final results are present on the Acg file when the general Save or Save As is done from the Editor that writes or re-writes the Acg file.

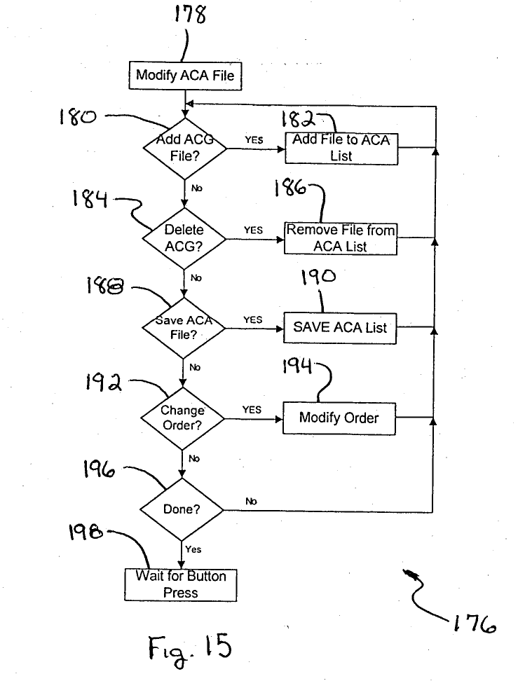

In FIG. 15, a representative high level flow diagram 176 for editing ACA files is shown. Essentially, beginning at block 178 initiation of a modification of a selected ACA file is commenced, followed by determination of whether an ACG file is to be added or deleted from the ACA file, as denoted by blocks 180, 182, 184, and 186. As long as additions or deletions are indicated, the program will loop back to block 180. Then, as indicated by blocks 188 and 190, the ACA file is saved and the program loops back to block 180, or proceeds on to determine whether the order of the ACGs is to be altered, as indicated by block 192. If the order is to be changed, it is modified as denoted at block 194 and the program loops back to block 180. If there is no change to the order, the program determines whether the modifications are done, as shown at block 196, and will either return to block 180 if there are, or will wait for a further command, as denoted at block 198.

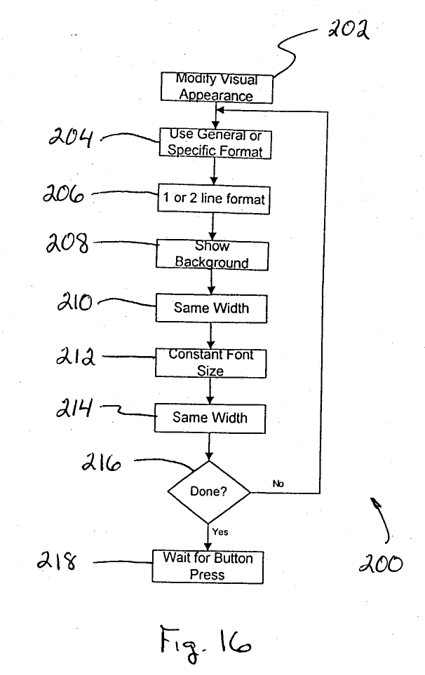

FIG. 16 is a high level flow diagram 200 summarizing the steps for modifying the visual display. The steps are initiated at block 202, and at block 204 a general or specific format is selected by the user. The user can select a 1 or 2 line format, as denoted at block 206; show a background, as denoted at block 208; use same width text lines, as denoted at block 210; select a constant font size, as denoted at block 212; select the same width, as denoted at block 214; and if not done, repeat steps 204, 206, 208, 210, 212 and 214 until done, as denoted at block 216. Then, when done, the program waits for another command, as denoted by block 218.

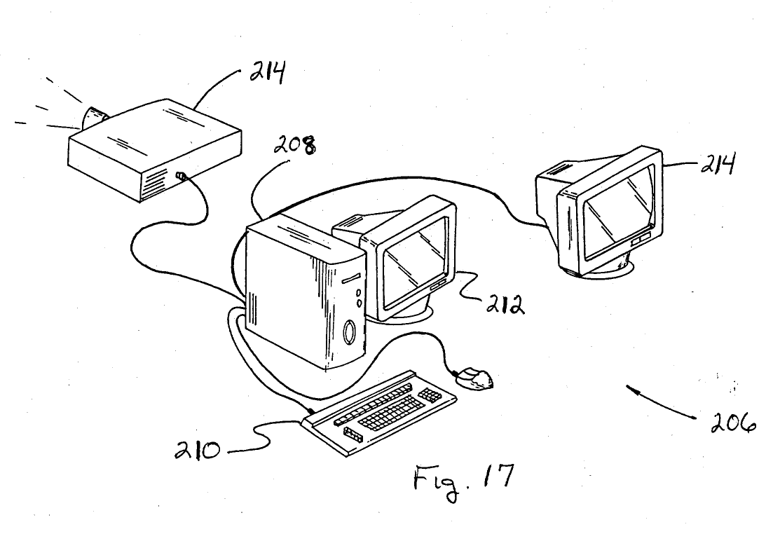

FIG. 17 shows a typical hardware set up 206 for operation of the system and method of the invention. The hardware set up can include, for instance, a well known commercially available personal computer 208 run by an operating program such as Windows XP Home or XP Professional available at the time of filing the of the present application from Microsoft Corporation, and including a suitable processor and memory for the programs and file storage requirements; a user input device 210 such as a keyboard for entering and editing information in files; a display device 212 such as a monitor for viewing the information as it is being entered and edited, and for cueing; and one or more optional display devices 214 for displaying the text and images, which can be a projection device, if desired, for projection onto a wall or screen, such as in accompaniment to an opera or other performance, or a personal device for use individually or in small groups of the audience. Any or all of devices 208, 210, 212 and 214 can be connected together by hard wire or wireless, in any conventional or other manner, as desired. It should be noted that it is anticipated that at least the Player program would be available for access or downloading over a wireless network such as the presently used World Wide Web or the like. Once accessed or downloaded, the player can be run as described above, and a music piece selected from the available ACG files, such as “Seguedille” referenced above, will be automatically played with the programmed images and text banners automatically displayed, showing the lyrics in the native or original language, and in the selected translation, which here is English. The images would automatically change as ordered in the selected program files and as timed by the cueing, and the text in the banners would change, either or both in content, colors, location, text size, also as programmed. In this way, the listener or audience is provided the benefit of seeing the lyrics in the language they are being sung in, preferably in an attractive and artistic form and with optional imagery, that complements and enhances the performing or playing of the musical piece. In the manual mode, with the timer disabled, the displaying of the text banners would be under control of the operator and would, for instance, be displayed on cue or as desired. In this way, a high degree of flexibility in displaying the texts and imagery can be achieved.

Thus, there has been shown and described a novel system and method for displaying text of music in multiple languages during the performing or playing of the musical piece, which overcomes many of the problems and provides the sought after properties set forth above. It will be apparent, however, to those familiar in the art, that many changes, variations, modifications, and other uses and applications for the subject system and method are possible. All such changes, variations, modifications, and other uses and applications that do not depart from the spirit and scope of the invention are deemed to be covered by the invention which is limited only by the claims which follow.

IBM-PC Machine Format

MS-WINDOWS Operating System Compatibility

LIST OF FILES

| Editor Ascii Code | | | |
|---|---|---|---|
| AdjustNudge.txt | 1 | KB | Feb. 11, 2003 |
| Background.txt | 1 | KB | Feb. 11, 2003 |
| Change_Colors.txt | 4 | KB | Feb. 11, 2003 |
| Cimi.txt | 154 | KB | Feb. 11, 2003 |
| Directions.txt | 1 | KB | Feb. 11, 2003 |
| Edit.txt | 22 | KB | Feb. 11, 2003 |
| Form1.txt | 32 | KB | Feb. 11, 2003 |
| Form2.txt | 6 | KB | Feb. 11, 2003 |
| Form3.txt | 1 | KB | Feb. 11, 2003 |
| Form4.txt | 1 | KB | Feb. 11, 2003 |
| Form5.txt | 1 | KB | Feb. 11, 2003 |
| FormPlayer.txt | 25 | KB | Feb. 11, 2003 |
| FrmEncode.txt | 25 | KB | Feb. 11, 2003 |
| Loudness_Adjust.txt | 1 | KB | Feb. 11, 2003 |
| ModifyTimes.txt | 6 | KB | Feb. 11, 2003 |
| Module2.txt | 8 | KB | Feb. 11, 2003 |
| Modulo1.txt | 45 | KB | Feb. 11, 2003 |
| MultiPick.txt | 13 | KB | Feb. 11, 2003 |
| MV2.txt | 16 | KB | Feb. 11, 2003 |
| MyClipboard.txt | 1 | KB | Feb. 11, 2003 |
| NewACGForm.txt | 3 | KB | Feb. 11, 2003 |
| Numeric.txt | 5 | KB | Feb. 11, 2003 |
| PicTree.txt | 24 | KB | Feb. 11, 2003 |
| PicturePiece.txt | 11 | KB | Feb. 11, 2003 |
| Prompter.txt | 3 | KB | Feb. 11, 2003 |
| SaveHow.txt | 4 | KB | Feb. 11, 2003 |
| Shortened.txt | 5 | KB | Feb. 11, 2003 |
| ShowEffects.txt | 2 | KB | Feb. 11, 2003 |
| Split_Lyrics.txt | 11 | KB | Feb. 11, 2003 |
| TextOrder.txt | 3 | KB | Feb. 11, 2003 |
| Three Lyrics.txt | 18 | KB | Feb. 11, 2003 |
| Timer.txt | 10 | KB | Feb. 11, 2003 |
| TinyPic.txt | 1 | KB | Feb. 11, 2003 |
| Welcome.txt | 1 | KB | Feb. 11, 2003 |
| Player Ascii Code | | | |
| ACGFileList code.txt | 2 | KB | Jan. 1, 2003 |
| Background code.txt | 1 | KB | Jan. 1, 2003 |
| ChangeACA code.txt | 3 | KB | Jan. 1, 2003 |
| Drag drop code.txt | 154 | KB | Jan. 1, 2003 |
| Form1 code.txt | 53 | KB | Jan. 1, 2003 |
| form2.code.txt | 53 | KB | Jan. 1, 2003 |
| form2nm code.txt | 1 | KB | Jan. 1, 2003 |
| Form3 code.txt | 1 | KB | Jan. 1, 2003 |
| Form4 code.txt | 1 | KB | Jan. 1, 2003 |
| Form5 code.txt | 1 | KB | Jan. 1, 2003 |
| Form6 code.txt | 1 | KB | Jan. 1, 2003 |
| frmAbout code.txt | 7 | KB | Jan. 1, 2003 |
| frmSplash code.txt | 4 | KB | Jan. 1, 2003 |
| Module CSMI code.txt | 154 | KB | Jan. 1, 2003 |
| Module 1 code.txt | 43 | KB | Jan. 1, 2003 |
| Prompter code.txt | 3 | KB | Jan. 1, 2003 |
| ShowESC code.txt | 1 | KB | Jan. 1, 2003 |
| Vertical_Control code.txt | 3 | KB | Jan. 1, 2003 |

What is claimed is:

1. A method for displaying text of a musical work in multiple languages as the work is performed or played, comprising the steps of:
a.) providing a file including segments of the text in at least two languages;
b.) providing information representative of when each of the segments of the text is to be sung in the work, respectively;
c.) providing a display device for displaying the segments of the text in the at least two languages; and then
d.) displaying the segments of the text in a sequential order responsive to the information when sung in the work.

2. The method of claim 1, wherein step b.) further comprises providing an automatic timer for determining when each of the segments of the text is to be sung in the work, and wherein step d.) further comprises automatically displaying the segments of the text in the sequential order as determined by the timer.

3. The method of claim 1, wherein step b.) further comprises providing cues when each of the segments of the text is to be sung in the work, respectively, and step d.) further comprises automatically displaying the cues at predetermined times before the segments are sung, respectively.

4. The method of claim 1, further comprising a step before step d.) of providing a file including segments of visual images to be displayed simultaneously with the segments of the text, respectively, and step d.) further comprises displaying the visual images when the segments of the text are displayed, respectively.

5. The method of claim 1, further comprising the step of providing a prompter for allowing a user to change the segments of the text when displayed.

6. The method of claim 5 wherein the prompter allows changing fonts of the segments of the text individually.

7. The method of claim 5 wherein the prompter allows changing colors of the segments of the text individually.

8. The method of claim 5, wherein the prompter allows changing display locations of the segments of the text individually.

9. The method of claim 5, wherein the prompter can display a list of the files and times during the performing or playing of the work when the segments of the text are to be displayed.

10. The method of claim 9, wherein the prompter allows incrementally changing the times during the performing or playing of the work when the segments of the text are to be displayed, respectively.

11. A system for displaying text of a musical work in multiple languages as the work is performed or played, comprising:
a computer including a processor, a memory device for storing at least one file including segments of the text in at least two languages, and a timer for timing when each of the segments of the text is to be sung in the work, respectively, and a display device for displaying the segments of the text in the at least two languages; and wherein the processor is operable for displaying the segments of the text in a sequential order responsive to the information when sung in the work.

12. The system of claim 11, wherein the memory device stores at least one file including information representative of at least one visual image to be displayed when a predetermined corresponding one or ones of the segments of the text are displayed, and wherein the processor is operable for displaying the at least one visual image on the display device when the corresponding one or ones of the text segments are displayed.

13. The system of claim 11, wherein the processor comprises an automatic timer for determining when each of the segments of the text is to be sung in the work and the processor is operable for automatically displaying the segments of the text in a sequential order as determined by the timer.

14. The system of claim 11, wherein the processor is programmed to provide timed cues when each of the segments of the text is to be sung in the work, respectively, and the processor will automatically display the cues at predetermined times before the segments are sung, respectively.
